(19) United States
(12) Patent Application Publication
(10) Pub. No.: US 2013/0250426 A1
(43) Pub. Date: Sep. 26, 2013

(54) MICROLENS SHEET AND MANUFACTURING METHOD THEREOF

(71) Applicants: Jiro Hattori, Atsugi (JP); Shoichi Masuda, Machida (JP); Satoshi Akutagawa, Setagaya (JP); Yasuhiro Kinoshita, Machida (JP)

(72) Inventors: Jiro Hattori, Atsugi (JP); Shoichi Masuda, Machida (JP); Satoshi Akutagawa, Setagaya (JP); Yasuhiro Kinoshita, Machida (JP)

(21) Appl. No.: 13/880,764

(22) PCT Filed: Oct. 24, 2011
(86) PCT No.: PCT/US11/57427

§ 371 Date: Apr. 22, 2013

(30) Foreign Application Priority Data
Nov. 17, 2010 (JP) 2010-257318

(51) Int. Cl. G02B 3/00

(52) U.S. Cl. CPC G02B 3/005
USPC 359/619; 264/2.5

(57) ABSTRACT

A microlens sheet that can be used as a floating image material is provided having a microlens array layer that can be produced by a more simple replication process, without requiring adjustment of the thickness. The microlens sheet has high scratch resistance and dust resistance. The microlens sheet has a microlens array layer including a first surface, and a second surface formed by replication, having a plurality of arranged convex lenses and one or more partition walls with a fixed height (Hw) that protrudes past the top of the convex lenses, a radiation sensitive layer which is disposed substantially at a focal position of the convex lenses on a side of the microlens array layer opposite the first surface, and which is substantially parallel to the second surface.

### FIELD

The present disclosure relates to a microlens sheet that can provide a three-dimensional composite image, and to a manufacturing method thereof.

### BACKGROUND

Products that use a holographic sheet or a microlens sheet are known as materials that allow an observer to see a three dimensional composite image. Of these, the microlens sheet disclosed in PCT International Publication No. WO 2001/63341 provides a composite image that appears to the naked eye of an observer to float above or below the microlens sheet. These floating images are referred to as “floating images”, and change in conjunction with changes in the viewing angle and distance of the observer. Furthermore, unlike a standard holographic sheet, the imaged microlens sheet is difficult to produce by replication.

A typical lens sheet for forming a floating image includes a microlens layer and a radiation sensitive layer located adjacent thereto, or a reflective layer that corresponds to a radiation sensitive layer, as described in PCT International Publication No. WO 2001/63341. Examples of a method of forming the microlens layer include using glass beads partially embedded in a binder layer, and forming a plastic microlens array layer using a mold as described in PCT International Publication No. WO 92/08998.

Specifically, PCT International Publication No. WO 92/08998 describes that “a base sheet has a first and second surface. The second surface is planar, and a substantially semiellipsoidal shaped microlens array is formed on the first surface. The shape of the microlens and the thickness of the base sheet are set such that parallel light is incident substantially perpendicular to the first surface, or in other words the array has a focal point that almost precisely corresponds to the second surface of the base sheet. In an embodiment of the present disclosure with a retroreflector shape, a reflective layer is included on the second surface of the base sheet.”

Furthermore, PCT International Publication No. WO 92/08998 describes the following steps as a manufacturing method:

a) A step of preparing a hardenable composition, b) a step of disposing the composition on a master surface with an array made of substantially ellipsoidal shaped concavities, c) a step of spreading the composition between a substantially flat base and the master, d) a step of hardening the composition to form a composite with a substantially ellipsoidal shaped microlens array attached to the base, and e) a step of removing the composite from the master to obtain a base sheet. Typically, the reflective layer of a mirror surface is a retroreflector and is used as the second surface of the base.

On the other hand, although PCT International Publication No. WO 2009/067308 is not a document that relates to floating images, PCT International Publication No.WO 2009/067308 describes a method of forming arranged curved surfaces by replication using gas bubbles as a part of the mold as a method of producing a shape with arranged hemispheroidal curved surfaces such as a lens array.

As disclosed in PCT International Publication No. WO 92/08998, lenses can be more regularly arranged when a microlens array prepared by replicating a mold is used as a microlens sheet for forming a floating image in comparison to a lens sheet that uses glass beads. However, a conventional microlens array used in a microlens sheet for forming a floating image is prepared by replicating a mold, and therefore there is a burden of preparing the mold itself.

A conventional microlens array is primarily made of plastic, but when a plastic lens is used, the lens surface is exposed to an air layer in order to achieve the necessary refractive index contrast for the lens, and therefore there are problems in relation to the tendency for scratching and dust adhering to the lens surface.

A conventional microlens sheet for floating images is designed such that a radiation sensitive layer is formed on a flat surface on the side opposite to the side on which the lens is formed, and parallel light that is incident substantially perpendicular to the microlens array surface is focused at the radiation sensitive layer. Therefore, when a microlens array is formed using a mold, the distance between the microlens array surface and the radiation sensitive layer, corresponding to the focal length, must be adjusted as accurately as possible. Therefore, the replication surface of the mold, in addition to the distance from the replication surface to the back surface, or in other words the thickness of the microlens array must be adjusted with high precision. The adjustment of the thickness of the microlens array is easily affected by the process conditions, and reproducibility of the thickness is not necessarily easily achieved.

### SUMMARY

In light of the foregoing conventional microlens array, an object of the present disclosure is to provide a microlens sheet for forming a floating image, which is a microlens array layer that can be produced by a more simple replication process, without requiring adjustment of the thickness, and that has high scratch resistance and dust resistance. Another object of the present disclosure is to provide a manufacturing method for this microlens sheet.

The microlens sheet of the present disclosure has a microlens array layer including a first surface, and a second surface formed by replication, the second surface having a plurality of arranged convex lenses and one or more partition walls with a fixed height (Hw) higher than the top of the convex lenses, and a radiation sensitive layer that is disposed substantially at a focal position of the convex lenses on a side of the microlens array layer opposite the first surface, and that is substantially parallel to the second surface.

The manufacturing method for the microlens sheet of the present disclosure includes the steps of preparing a mold comprising a mold surface that has a plurality of concavities, each being inverse of the convex lens shape, and one or more trenches each having a fixed depth deeper than the concavities; replicating the mold surface so as to form a microlens array layer having a first surface, and a second surface with a plurality of convex lenses formed by replication; and disposing a radiation sensitive layer at substantially the focal position of the convex lenses on a side of the microlens array layer opposite the first surface and substantially parallel to the second surface.

By using the microlens sheet of the present disclosure and the manufacturing method thereof, a radiation sensitive layer is formed on a second surface side having a plurality of arranged convex lenses and one or more partition walls with a fixed height that protrude past the top of the convex lenses, which have been formed by replication. Therefore the distance between the convex lenses and the radiation sensitive layer can be adjusted by the height of the partition walls. The adjustment of the actual thickness of the microlens sheet is not necessary, and reproduction of the partition wall height can easily be achieved using a replication process. Therefore, a microlens sheet where the position of the radiation sensitive layer can be adjusted with good reproducibility can be provided using a more simple replication process. Furthermore, with this configuration, because the surface of the convex lens is not exposed, a microlens sheet with excellent scratch resistance and dust resistance on the lens surface can be provided.

### BRIEF DESCRIPTION OF THE DRAWINGS

FIG. 1 is a cross-sectional view of a microlens sheet according to an embodiment of the present disclosure.

FIG. 2 is a cross-sectional view of a microlens sheet according to another embodiment of the present disclosure.

FIG. 3 is a cross-sectional view of a microlens sheet according to yet another embodiment of the present disclosure.

FIG. 4 is a conceptual diagram of a floating image that uses a microlens sheet according to an embodiment of the present disclosure.

FIGS. 5(a)-5(f) are various views for each step of an example of a manufacturing method for a microlens array layer according to an embodiment of the present disclosure.

FIGS. 6(a)-6(b) are various views of a base mold that is used in an embodiment of the present disclosure.

FIGS. 7(a)-7(c) are various views of each step showing the manufacturing steps for a microlens array layer for an embodiment of the present disclosure.

FIG. 8 is a conceptual block diagram showing the configuration of an image drawing device for the radiation sensitive layer that is used in an embodiment of the present disclosure.

### DETAILED DESCRIPTION

The microlens sheet of an embodiment of the present disclosure contains at least a microlens array layer and a radiation sensitive layer. The microlens array layer has a first surface and an opposing second surface, and the second surface has convex lenses formed by a replication method using a mold and partition walls with a fixed height (Hw) that protrude past the top of the convex lenses. The radiation sensitive layer is configured to be directly or indirectly adjacent to the opposite side of the microlens array layer as the first surface, or in other words the second surface, and extends substantially parallel to the second surface at substantially the position of the focal point of the convex lenses.

As used herein, the phrase “the radiation sensitive layer is at the position of the focal point of the convex lenses” means that the second surface is a surface that includes the position where light that is incident upon each of the convex lenses from a direction substantially perpendicular to the second surface is focused.

The phrase “substantially parallel to the second surface” refers to being substantially parallel to a plane that contains the top of the plurality of convex lenses formed on the second surface, being substantially parallel to a plane that contains the end surfaces of the plurality of partition walls, or being substantially parallel to a plane containing base points of the second surface as described below. The phrase “substantially perpendicular to the second surface” refers to a direction perpendicular to a surface that is substantially parallel to the second surface.

The phrase “height of the partition walls (Hw)” refers to the height from a plane (base point plane) that includes base points of the second surface defined as the interface between the convex lenses and the partition walls, which is the lowest area of the second surface.

The microlens sheet of this embodiment can be formed using a mold with a plurality of concavities that are arranged to correspond to the shape of the convex lenses and one or more fixed-depth trenches that are deeper than the concavities, formed in the replication surface.

With the microlens sheet of this embodiment, convex lenses and partition walls with a fixed height (Hw) produced by replication are provided on the second surface, and the radiation sensitive layer is positioned directly or indirectly adjacent to the second surface of the microlens array layer, and therefore the distance to the radiation sensitive layer can be adjusted by the height of the partition walls. Therefore, controlling the thickness of the microlens sheets is not necessary. The height of the partition walls (Hw) is determined by the depth of the trenches in the surface of the mold, and therefore the height of the partition walls will not vary between products and can be formed with good reproducibility by using the same mold. Therefore, the manufacturing process can be further simplified, and the position of the radiation sensitive layer can be more accurately adjusted. With this configuration, the radiation sensitive layer is located on the second surface side that has the convex lenses, and therefore the convex lens surface is not exposed to the outside. Therefore, scratches and dust will not easily form on the surface of the lens.

It is noted that the term “microlens” is not restricted to a specific size, and any lens size that can be used for forming a floating image is acceptable. For example, a microlens with a lens diameter between approximately 1 μm and approximately 5 mm can be suggested. Incidentally, the lens diameter referred to herein is the width of the lens in the maximum cross-section of a convex lens. The maximum cross-section refers to the cross-section with the largest lens cross-sectional area in a cross-section perpendicular to the second surface of the microlens array layer.

The microlens sheet of this embodiment is described below while referring to the drawings.

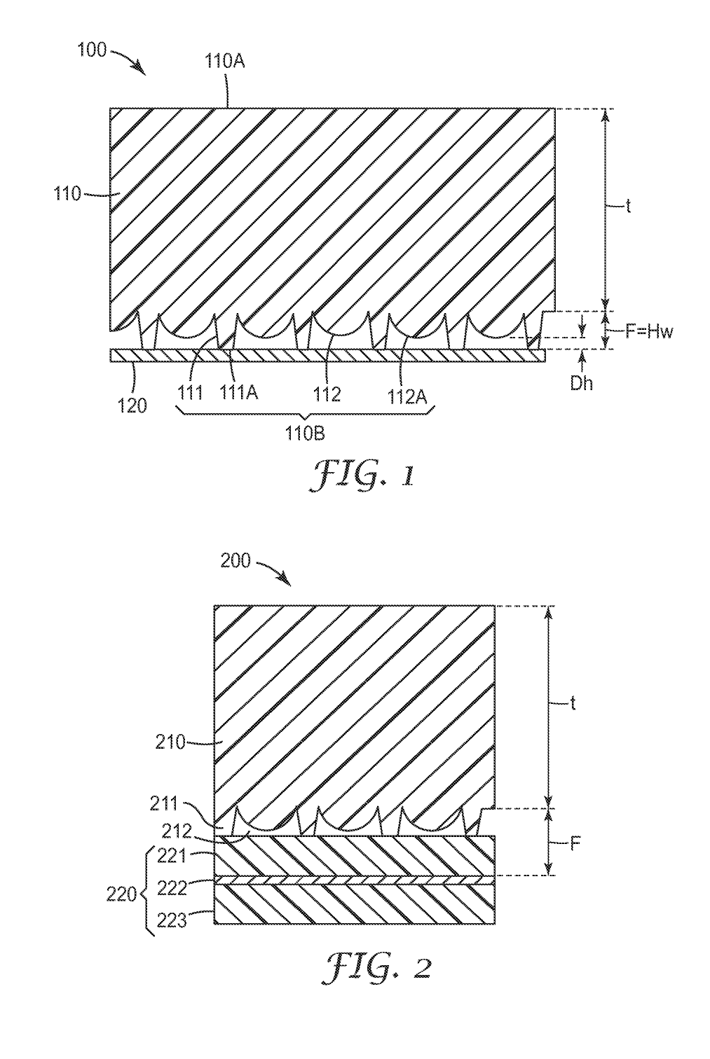

A conceptual cross-sectional view partially showing a microlens sheet 100 of this embodiment is shown in FIG. 1. The microlens sheet 100 has at least a microlens array layer 110 and a radiation sensitive layer 120. The microlens array layer 110 has a substantially flat first surface 110A and a second surface 110B formed by replication using a mold. A plurality of arranged microlenses which are convex lenses 112 and a plurality of partition walls 111 with a fixed height (Hw) higher than the top of the convex lenses are formed on the second surface 110B. The radiation sensitive layer 120 is configured to the substantially parallel to the second surface 110B at a position that substantially connects the focal points of the convex lenses, or in other words, the focal points of light that is incident in substantially a perpendicular direction on the convex lenses. The base points of the height (Hw) of the partition walls 111 are positioned at the interface between the partition walls 111 and the convex lenses 112. A height difference Dh exists between the most protruding end part 111A of the exposed surface of the partition walls 111 and the top 112A of the convex lenses 112, or in other words the highest part of the curved surface of the convex lens 112.

Convex lenses two-dimensionally arranged with fixed regularity are arranged on the second surface 110B of the microlens array layer 110. The arrangement pattern includes arbitrary arrangement patterns such as a row pattern, matrix pattern, staggered matrix pattern, or radiating pattern. The bottom plane shape of the convex lenses is not particularly restricted, and can be either a polygonal shape such as a triangle, square, or hexagon, or a round or elliptical shape. The diameter of the convex lenses and the pitch of the convex lenses in the microlens array layer 110 are not particularly restricted. The size of the image to be formed can be selected based on the fineness.

The partition walls 111 are adjacent to the convex lenses 112, and for example, can be arranged so as to surround the periphery of each of the convex lenses 112, or can be formed only on a part of the second surface 110B of the microlens array layer 110. For example, a single ring shaped partition wall can be formed on the second surface 110B on the outer circumference of the region where the convex lens is formed, or can be formed to surround the region of a plurality of convex lenses.

The surface area ratio of the first partition wall 111 and the convex lenses on the second surface of the microlens array layer is not particularly restricted, and for example can be between 1:10 and 10:1. A floating image can be formed even if the area of the second surface occupied by the convex lenses 112 is smaller than the area occupied by the partition walls 111, but a more defined floating image can easily be formed if the area occupied by the convex lenses 112 is larger. The convex lenses are not necessarily uniformly arranged on the entire surface of the second surface, but are preferably uniformly arranged at least in the region that forms the floating image.

The partition walls 111 can support the radiation sensitive layer 120 located adjacently to the second service 110B, or can support a laminate body that includes the radiation sensitive layer as described below. Because the radiation sensitive layer or the laminate body is supported by the partition walls 111, the surface of the convex lenses 112 will be separated from the adjacent layer and will be exposed to an air layer, and thus a high refractive index contrast can be ensured at the lens surface.

By aligning the height (Hw) of the partition walls 111, the laminate bodies can be supported substantially parallel to the second surface 110B of the microlens array layer 110. By adjusting the height (Hw) of the partition walls 111, the radiation sensitive layer 120 can be provided at substantially the focal point position of the convex lenses.

It is noted that positioning the radiation sensitive layer substantially at the focal point position of the convex lenses includes not only the case where the focal point position is on the radiation sensitive layer, but may also include the case where the focal point position is to the outside of the radiation sensitive layer thickness, and the required precision is dependent on the application, so long as a floating image that can be distinguished by the naked eye of the observer can eventually be formed, and the required accuracy depends on the application. For example, if the distance from the base points of the second surface of the microlens of a layer is between 50 and 100 μm, an error of approximately plus or minus 15% or less, or 5% or less may be included.

With the microlens array layer shown in FIG. 1, the cross-sectional shape of the partition walls 111 is trapezoidal, but the shape is not restricted so long as the height is aligned. The cross-sectional shape can be polygonal such as triangular, square, or rectangular, or a shape with a partially curved surface. It is noted that the planar shape of the partition walls 111 is not particularly restricted. The partition walls can be independently formed in the plurality of regions, or as described above, can be formed to extend around the periphery of the convex lenses.

As described above, with the microlens sheet of this embodiment, the distance between the microlens array layer 110 and the radiation sensitive layer 120 can be adjusted by the height (Hw) of the partition walls 111, and therefore there is no need to adjust the thickness of the microlens array layer 110 itself. In other words, the thickness (t) of the microlens array layer 110 excluding the height (Hw) of the of the partition walls 111 shown in FIG. 1 is not particularly restricted. Therefore, the thickness of the microlens array layer 110 does not need to be adjusted to the focal length of the convex lenses 112 during the replication process for forming the microlens array layer, and thus the thickness can be freely set. Although not particularly restricted, the thickness can be 1 μm or greater, 1 mm or greater, or even 10 mm or greater, for example.

During the process of forming the microlens array layer 110, the process factors to be adjusted are reduced so process management is further simplified. The height (Hw) of the partition walls 111 can be reproduced relatively easily if formed by a replication process using the same mold, and therefore process management is further simplified.

It is noted that the first surface of the microlens array on which the convex lenses are not formed is not necessarily a flat surface, and the surface may have protrusions and recesses, or the entire surface may be a curved surface.

The height of the partition walls 111 can be determined considering the focal length of the convex lenses 112. However, as described below, if one or more resin layers or the like are laminated between the radiation sensitive layer 120 and the microlens array layer, the thickness should be adjusted while considering the thickness of these layers and subtracting that amount.

It is noted that in this embodiment, the partition walls 111 are higher than the convex lenses 112, and the surface of the convex lenses is separated from other adjacent layers, and therefore an air layer can be provided. The lens surface that may be easily scratched is protected by the radiation sensitive layer or by a laminate body that includes the radiation sensitive layer and other resin layers as described below, with an air layer therebetween, while providing the required refractive index contrast for a lens function, and therefore the scratch resistance is enhanced and adhesion of dust onto the surface of the convex lens 112 can be prevented. The difference in the height of the partition walls 111 and the height of the top of the convex lenses 112 should be so as to provide an air layer and, for example, can be 0.1 μm or higher, or 1.0 μm or higher, and 1 mm or less, 100 μm or less, or even 10 μm or less.

The microlens array layer 110 of this embodiment can be manufactured from materials made by hardening a hardenable fluid, and although not particularly restricted, a resin or ceramic material or the like can be used. The material of the microlens array layer 110 is preferably a material that effectively transmits at least the light wavelength to be used. Typically, material with a transmissivity of 60% or higher, 70% or higher, or 80% or higher is preferably used in the visible light range (400 nm to 800 nm). For example, the material can be formed from a synthetic resin exemplified by polyvinyl chloride fluorine-based resins, polyurethane resins, polyester resins, polyolefin-based resins, acrylic-based resins, methacrylic-based resins, silicone resins, epoxy resins and the like; silicon oxide; titanium oxide; or ceramics such as various glass materials.

The radiation sensitive layer 120 is a radiation sensitive material on which it is possible use light irradiation to record a pattern corresponding to the floating image which is the subject image. The radiation sensitive material can be the radiation sensitive material disclosed in PCT International Publication No. WO 01/633341. Any material can be used that can change to a form with a difference in contrast between portions exposed to a predetermined level of visible light or other irradiation and unexposed portions through composition change, laser ablation of the material, a change in phase, or the like. Specifically, the material can be a film formed from a metal, a polymer, a semiconductor material, or a mixture of these materials.

For example, a metal foil or a metal vapor deposition layer can be used as the radiation sensitive material. Examples include aluminum, silver, copper, gold, titanium, zinc, tin, chromium, vanadium, tantalum, and alloys and oxide films of these metals. These metal radiation sensitive materials may be irradiated using, for example, excimer flashlamps, passively Q-switched microchip lasers, Q-switched neodymium-doped yttrium aluminum garnet (Nd: YAG), neodynium-doped yttrium lithium fluoride (Nd: YLF), titanium-doped sapphire (Ti:sapphire) lasers, or the like. The radiation sensitive material of the irradiated portion can then be removed by ablation.

It is possible to use a known image forming method as described in PCT International Publication No. WO 01/063341 to form the pattern for the subject image in the radiation sensitive layer 120. For example, the microlens sheet may be irradiated with laser light first passed through an optical system for collimating and then focused in such a way that a focal point is above or below the microlens sheet. The laser light is refracted at a predetermined angle by each of the micro lenses, and converged on to the radiation sensitive layer. The radiation sensitive material on the irradiated portion is removed by ablation. An irradiation position of the laser light is then moved based on a pattern of the subject image to draw the pattern of the subject image in the radiation sensitive layer 120.

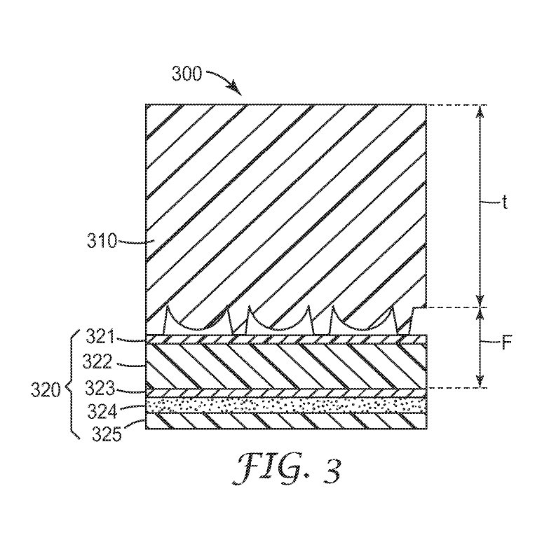

Next, another embodiment of the microlens sheet is described using FIG. 2 and FIG. 3.

As shown in FIG. 2, the microlens sheet 200 has a plurality of arranged convex lenses 212 and a plurality of partition walls 211 with a fixed height (Hw) that protrude past the top of the convex lenses, formed on the second surface of the microlens array layer, and a laminate body 220 with one or more resin layers that includes a radiation sensitive layer 222 may be provided adjacent to the opposite side as the first surface, or in other words adjacent to the second surface. The structure of the laminate body 220 is not particularly restricted. For example, the radiation sensitive layer 222 can be coated onto a resin film 223, and then a coating resin layer 221 can be laminated thereon.

For example, a commercially available laminate film produced by metal vapor deposition onto a resin film such as PET can be used as the resin film 223 and the radiation sensitive layer 222. A commercially available resin film can be laminated onto this commercially available laminate film as the resin layer 221. Alternatively, a thermosetting, thermoplastic, or UV curable resin can be coated onto the radiation sensitive layer 222 using a coating method such as a knife coater or blade coater or the like, and then hardened by a method such as heating or UV light radiation to obtain a resin layer 221 with a fixed thickness. In this case, the distance (F) from the second surface of the microlens array layer 210 to the radiation sensitive layer 222 can be adjusted with reference to the sum of the thickness of the resin layer 221 and the height of the partition walls (Hw), so that the radiation sensitive layer 222 can be substantially located at the focal points of the convex lenses. It is noted that if a resin layer with tackiness is used as the resin layer 221 that is in direct contact with the partition walls, the microlens array layer 310 and the laminate body 320 can easily be fastened together.

With the microlens sheet 300 shown in FIG. 3, a laminate body 320 with an added adhesive layer 324 is provided adjacent to the microlens array layer 310. For example, as shown in FIG. 3, the laminate body 320 has a resin layer 321 on one side of a commercially available resin film 322 and a radiation sensitive layer 323 on the other side, and furthermore a peeling film 325 and an adhesive layer 324 are provided on the surface of the radiation sensitive layer 323. During use, the microlens sheet 300 can be attached to the surface of an object using the adhesive layer 324 by removing the peeling film 325. In this case, the distance (F) from the second surface of the microlens array layer 210 to the radiation sensitive layer 222 can be adjusted with reference to the sum of the thickness of the resin layer 321, the thickness of the resin film, and the height (Hw) of the partition walls, and therefore the radiation sensitive layer 222 can be located substantially at the focal point positions of the convex lenses.

In this manner, the structure of the laminate body that includes the radiation sensitive layer is not restricted, and the number and types of laminated resin layers are not restricted. The radiation sensitive layer should be provided to extend substantially parallel to the second surface of the microlens array layer substantially at the position of the focal points of the convex lenses of the microlens array layer. Typically, the resin layers that are included in the laminate body preferably are materials with a transmissivity of at least 60% or higher, or 70% or higher, in the visible light range (400 nm to 800 nm). For example, the material can be formed from a synthetic resin exemplified by polyvinyl chloride fluorine-based resins, polyurethane resins, polyester resins, polyolefin-based resins, acrylic-based resins, methacrylic-based resins, silicone resins, epoxy resins and the like. It is noted that a glass or ceramic with a similar transmissivity in the visible light range can also be used in place of the resin layer.

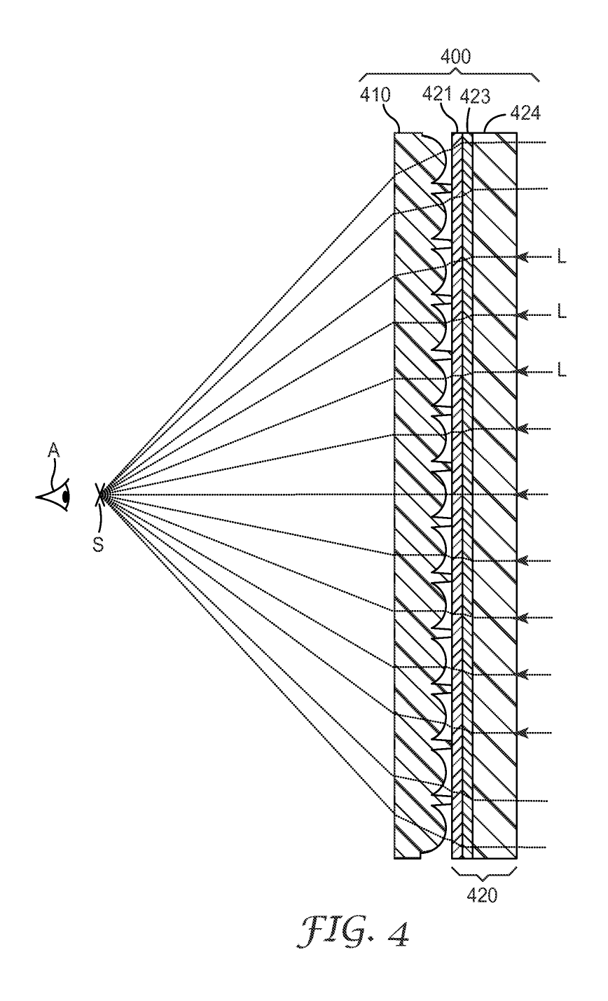

FIG. 4 shows an example of a conceptual diagram of a floating image observed using the microlens sheets 400 of this embodiment. If substantially parallel light (L) is irradiated from the back surface (right side of the drawing) of the microlens sheet 400, the irradiated light that is selectively transmitted through the radiation sensitive layer 423 on which an image pattern is replicated will penetrate into the microlens array layer 410 through the resin layer 421. At this time, the irradiated light is refracted based on the curvature of the lens of each convex lens surface formed on the second surface and on the differences of the medium at the interface, and is further refracted by the first surface of the microlens array layer 410. Thus, an image is formed on the front surface of the microlens sheet 400. As a result, to an observer (A), it appears just as if an image (S) of the subject image is floating in front of the microlens sheet 400.

It is noted that the first surface of the microlens array layer can be coated with an antireflective film. By coating with an antireflective film, the efficiency of light contributing to forming the image is enhanced, and a more defined floating image can be formed.

In FIG. 4, the case is shown where light is irradiated from the second surface side of the microlens sheet 400, or in other words from the backside of the microlens sheet 400, but if a metal film or the like that can reflect light is used as the radiation sensitive layer 423, light irradiated from the front side of the microlens sheet 400, or in other words incident light from the side of the observer, such as natural light for example, can be used as the light source. Natural light having a substantially perpendicular incidence upon the surface of the radiation sensitive layer 423 will be reflected in a direction substantially perpendicular to the surface of the radiation sensitive layer 423, and therefore the light path will be substantially the same as the light path shown in FIG. 4, and the same floating image can be obtained in front of the microlens sheet 400. In other words, regardless of whether transmitted light or reflected light is used, the floating image will be viewable by the naked eye.

The position of the image that is formed, or in other words, the position of the floating image can be adjusted by changing the position of the focal point of a laser that irradiates an image pattern on the radiation sensitive layer 423 when forming a drawing image. In addition to forming the image in front of the microlens sheet 400, it is also possible to form the image behind the microlens sheet 400. Furthermore, the floating image will also move to track the movement of the observation point if the position of viewing is changed.

The image obtained with the microlens sheeting of this embodiment differs from a holographic image in being difficult to replicate, making the image suitable for use in passports, ID badges, event passes, loyalty cards, product recognition formats, and in verification and recognition advertising as an image that is secure and cannot be used illegitimately. Further, based on design characteristics of the floating image, the microlens sheeting can be widely used in graphic applications such as in distinctive imaging for lettering, and the like on police cars, fire trucks, or other emergency vehicles, in information presentation images of kiosks, electrically lit nighttime displays, vehicle dash boards, electronic devices, and the like; in decoration of business cards, name-tags, home electronics, pieces of art, clothes, shoes, and packaging such as bottles and boxes. Specifically, the image can be used to provide a high-quality image for containers of cosmetic materials or the like, or to display in three dimensions brand names and functions or the like of imaging devices such as televisions and portable terminals, thus contributing to the design characteristics.

Next, the method of manufacturing the microlens sheet of this embodiment is described below.

The microlens sheet of this embodiment can be formed using a mold with a plurality of concavities that are arranged to correspond to the shape of the convex lenses and one or more fixed-depth trenches that are deeper than the concavities, formed in the surface of the mold. The manufacturing method of the microlens sheet of this embodiment includes a step of preparing a mold, a replicating step of replicating the shape of the mold surface to the surface of a resin layer, and forming a microlens array layer with a first surface and a second surface which is the replication surface, and a step of providing a radiation sensitive layer substantially parallel to the second surface of the microlens array layer substantially at the focal point position of the convex lenses.

In the replicating step, as an alternate to a method where a hardenable fluid is supplied to the surface of the mold, the hardenable fluid is hardened and then the hardened material is peeled, a method where a mold surface is replicated onto a thermoplastic resin plate by pressing a heat resistant mold onto a thermoplastic resin plate at high temperature can also be used. It is noted that the mold that is used in the replicating step of forming the microlens array layer is conveniently referred to herein as a “master mold”.

The method of forming the master mold itself is not restricted. For example, a master mold can be prepared by forming a shape that is inverse to the shape to be formed on the second surface of the microlens sheet (replication surface) onto the surface of a metal, ceramic, or resin material using a conventional mechanical process. However, with the method of manufacturing a mold using a standard mechanical process, a lens array with minimal aberration cannot easily be produced, so a mold for the microlens array layer is preferably performed using a more simple process.

With the method of forming the microlens array layer of this embodiment described below, a replicating method that proactively uses air bubbles as a portion of the mold is used in the aforementioned step of preparing the master mold. Thus a smooth convex lens with minimal warping and partition walls peripheral thereto that are difficult to obtain by a mechanical grinding method or the like can be obtained by a simple process.

A manufacturing method for a microlens array layer that includes a step of preparing a master mold of this embodiment using gas bubbles is described below. This manufacturing method includes in a first replication process (1) a step of preparing a base mold (referred to as the “first mold”) with a mold surface provided with an arranged pattern, (2) a step of supplying a hardenable fluid to the mold surface in order to capture gas bubbles on the arranged patterns, (3) a step of hardening the hardenable fluid, and (4) a step of removing the hardenable layer obtained from the base mold.

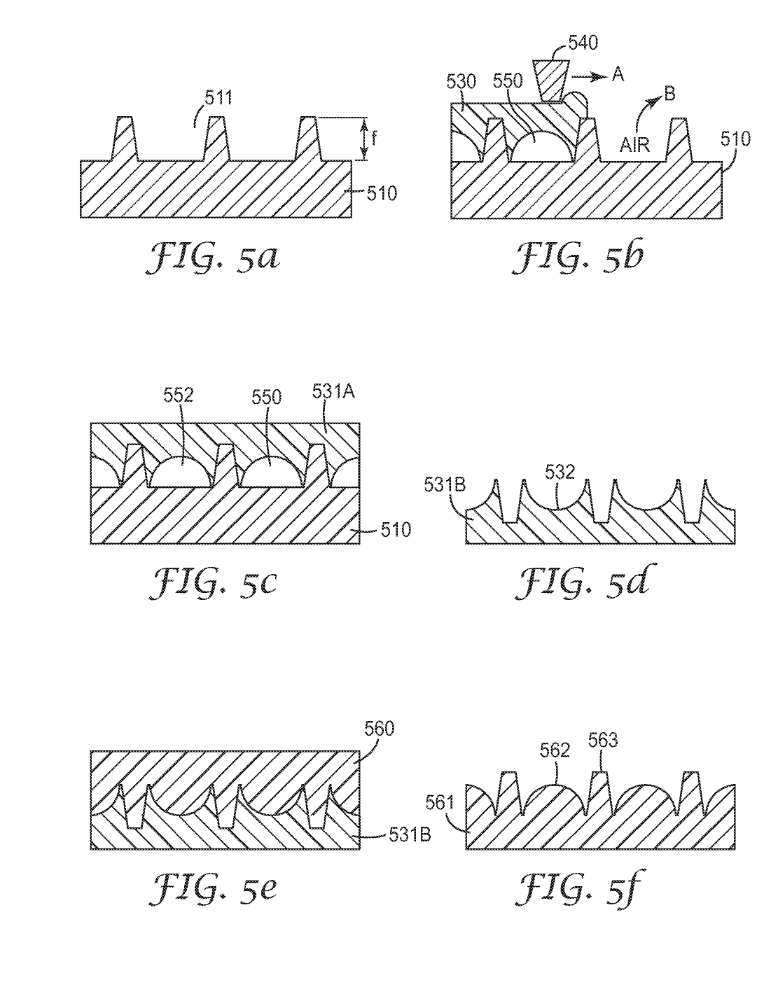

First, a method of manufacturing the microlens array layer of this embodiment is briefly described below while referring to FIG. 5(a) through FIG. 5(f).

A base mold 510 with a mold surface having an arranged pattern is prepared in the first replication process of this embodiment (refer to FIG. 5(a)). FIG. 5 shows an example of a process that uses a base mold with truncated pyramid or conic trapezoid shaped concavities 511. It is noted that in the present specification, the term “base mold”, specifically refers to the portion of the mold that does not include gas bubbles that is used in a process where gas bubbles are captured on the replication surface and the gas bubbles are directly replicated (hereinafter referred to as the “first replication process”). It is noted that the term “base mold” is also conveniently referred to as the “first mold”.

It is noted that the gas that forms the “gas bubbles” that are used in this process is not particularly restricted. The replication process can be performed in air if air is used, and therefore a more simple process can be achieved, but it is also possible to use an inert gas or the like such as nitrogen or argon. The shape of the gas bubbles can be adjusted using a material that forms the concavities in the base mold and by the various process conditions described below.

The gas bubbles that are formed on the mold surface should be present during replication, and should be a material that can substantially form a mold surface where the gas bubbles are integrated with the surface of the base mold during replication. The “gas bubble arrangement” formed in the base mold corresponds to the arrangement of the concave lenses in the microlens array layer of this embodiment. In one example of the method of manufacturing the microlens array layer of this embodiment, convex lenses with substantially the same shape and size can be two-dimensionally arranged, but convex lenses with different shapes and sizes can also be arranged on the same surface.

Next, the hardenable fluid 530 is coated onto the mold surface while capturing the gas bubbles 550 in the concavities 511 of the base mold 510 (refer to FIG. 5(b)). Next, the hardenable fluid 530 is hardened (refer to FIG. 5(C)) to obtain a hardened layer 531A. Next, the hardened layer 531A replicated by the surface of the base mold and the gas bubbles is removed (peeled) as a structural body 531B from the base mold 510 (refer to FIG. 5(d)).

The structural body 531B removed from the base mold 510 can be used as a master mold for forming a microlens array layer with a plurality of concave lenses and trenches deeper than the concave lenses formed around each concave lens (hereinafter conveniently referred to as “second mold”).

The hardenable fluid used herein is not particularly restricted. For example, a resin or a ceramic material or the like can be used. Next, a microlens array layer of this embodiment provided with convex lenses can be manufactured by performing a replication process (referred to as “second replication process”) as shown in FIG. 5(e) and FIG. 5(f). In other words, the structural body 531B obtained by the aforementioned process is used as a master mold, and the hardenable fluid 560 is coated on to the replication surface (refer to FIG. 5(e)) and hardened. Next, the structural body 561 which is a solid is removed from the second mold (structural body 31B) (refer to FIG. 5(f)). In this second replication process, a standard conventional replication process can be used, where gas bubbles are not included on the replication surface. Therefore, the removed structural body 561 can be used as a microlens array layer that has a plurality of arranged convex lenses and partition walls that enclose the convex lenses adjacent to each of the convex lenses.

The material of the hardenable fluid 560 that is used in the second replication process is not particularly restricted, but preferably the material of the microlens array layer is a material that effectively transmits the wavelength of light that is used. Typically, materials with a transmissivity of at least 60% or higher, or 70% or higher, in the visible light range (400 nm to 800 nm) are preferable For example, the material can be formed from a synthetic resin exemplified by polyvinyl chloride fluorine-based resins, polyurethane resins, polyester resins, polyolefin-based resins, acrylic-based resins, methacrylic-based resins, silicone resins, epoxy resins and the like; silicon oxide; titanium oxide; or ceramics such as various glass materials.

In the first replication process, in the region where the gas bubbles supplied to the surface of the base mold and the hardenable fluid make contact, the gas bubbles will attempt to form a spheroidal convex curved surface in order to minimize the interfacial area so that the interfacial energy with the hardenable fluid will be minimized. In actuality, other parameters such as buoyancy, weight, and the viscosity of the hardenable fluid have an effect, and in proximity to the region where the gas bubbles contact to the surface of the base mold, the interfacial tension between the gas bubbles and the mold surface and the interfacial tension between the hardenable fluid and the mold surface also have an effect. However, if the forces are applied substantially symmetrically to the top of the convex curved surface or to the overall convex curved surface of the gas bubbles, the gas bubbles can form a uniform and smooth convex curved surface without deforming to a warped shape. Therefore, the concavities obtained using a replication surface that includes gas bubbles obtained by the first replication process have a smooth concave curved surface that is an inverse of the outer shape of the gas bubbles. Furthermore, the convex lenses obtained by replicating the concave curved surfaces can have a smooth convex curved surface.

Using the first and second replication processes described above, a microlens array layer which conventionally has required a complex process and much processing time can be manufactured by a simple process by replicating the gas bubbles arranged on the replication surface using the hardenable fluid.

In particular, with the first replication process, gas bubbles are proactively or in other words intentionally captured, and the gas bubbles are used as a part of the replication surface. Therefore, the process differs from a conventional replication process where replication is performed without including gas bubbles, or if gas bubbles are included, a degassing process is performed to reduce the pressure. In the first replication process, if the gas enclosed in the gas bubbles is a gas taken from the atmosphere for example, the process can be performed in air, and therefore special equipment such as a vacuum chamber will not be required and production can be performed using extremely simple manufacturing equipment.

On the other hand, the second replication process can be a conventional replication process, and the specific replication method is not restricted. Similar to the first replication process, a UV light hardening resin, thermosetting resin, or two-pack ambient temperature hardening resin or the like can be coated, hardened, and then peeled, or a replication method using a hot press with a thermoplastic resin or an electrocasting method or the like can be used.

The convex lenses obtained by the replication method that uses gas bubbles according to this embodiment will have a smooth surface, and although dependent on the material that is replicated, the surface roughness Ra at the center part of the lens can be for example, 100 nm or less, 50 nm or less, 10 nm or less, or even 5 mm or less. A convex lens with extremely minimal aberration can be formed by replicating the natural shape of the gas bubbles.

The various steps of the manufacturing process for the microlens array layer will be described below in detail.

As shown in FIG. 5(a), in the first replication process, a base mold 510 is prepared with a mold surface where a plurality of concavities 511 is arranged in a prescribed pattern, but the arranged pattern formed on the surface of this base mold corresponds to the arrangement of the convex lenses to be obtained in the microlens array layer.

Herein, the phrase “surface of the base mold” refers to the surface of the base mold itself for the case where gas bubbles are not provided. If gas bubbles are not present during replication, the shape of the surface of the base mold itself will be replicated onto the replicated object. However, in the first replication process of this embodiment, gas bubbles are captured in the concavities that form the mold surface when the hardenable fluid is coated onto the mold surface, and therefore the gas bubbles and the surface of the base mold are integrated and substantially form the mold surface.

By providing concavities that are arranged with high positional precision beforehand on the surface of the base mold, a microlens array layer that provides concave lenses arranged with high positional precision can be obtained. The size and shape of the captured gas bubbles can be adjusted by forming concavities with a predetermined shape and size on the surface of the base mold. By using a base mold where concavities of the same size and shape are arranged, gas with substantially the same size and shape can be captured in the concavities, and therefore concave lenses with substantially the same size and shape can be obtained.

It is noted that the pattern of the arranged concavities of the base mold can be an arbitrary arranged pattern that extends uniformly in two dimensions such as in rows, a square matrix arrangement, a staggered matrix arrangement, or a radiating arrangement. The pattern can be selected to match the pattern of the arranged convex lenses that are finally formed in the microlens array layer. Furthermore, the bottom planar shape and size of the convex lenses eventually obtained is determined by the shape of the bottom surface of the concavities of the base mold that is used.

The material of the base mold 510 can typically be a resin material, but this is not a restriction, and any organic material or any inorganic material such as metal, glass, or ceramic, as well as any organic and inorganic composite material can be used. The dimensions of the base mold 510 can be any dimension that corresponds to the size of the microlens to be formed, but for example, a vertical dimension of between 1 mm and several thousand millimeters, a lateral dimension between 1 mm and several thousand millimeters, and a thickness dimension between 10 μm and several tens of millimeters can be suggested.

The shape of the surface of the base mold 510 can be a variety of shapes, and for example, as shown in FIG. 5(a), a base mold 510 with a cross section having truncated pyramid or conical shaped concavities, or a base mold with a cross section having rectangular prism or cylinder shaped concavities can be used.

An example of the size of the concavities that can be formed in the surface of the base mold 510 has a depth of between 0.1 μm and several tens of millimeters, and an opening area between 0.01 μm² and several hundred mm², but these are not restrictions. The depth of the concavities defines the height of the final partition walls to be obtained, so the depth is determined by considering the focal distance of the convex lenses and the structure of the radiation sensitive layer or laminate body containing the radiation sensitive layer that is adjacent to the microlens array layer. The depth of the plurality of concavities is preferably aligned.

In FIG. 5(b), the hardenable fluid 530 is coated onto the surface of the base mold 510, and at the same time a portion of the surrounding gas such as air is captured in the current cavities 511 of the base mold 510. In this step, the method of coating the fluid on to the mold surface is not particularly restricted, but the optimal coating method can be selected to match the type of hardenable fluid, and the size and shape and the like of the structural body.

The coating equipment can typically be a knife coater, but this is not a restriction, and various other types of coating equipment such as a bar coater, blade coater, or roll coater can be used. It is noted that if a thermoplastic resin is used as the hardenable fluid, a heated knife coater that has been heated to a temperature that can provide the resin with the necessary fluidity can be used.

With this embodiment, if a knife coater is used for example, the hardenable fluid is supplied to one end of the base mold surface, and then a blade 540 with an edge that has been secured at a fixed height is moved so as to spread out the hardenable fluid across the entire surface of the base mold. In other words, with this embodiment, the hardenable fluid is coated onto the surface of the base mold 510 by a moving the blade 540 at a fixed speed in the direction shown by arrow A (from left to right). At this time, a portion of the surrounding gas is captured as gas bubbles 550 in the concavities 511 of the base mold 510.

The captured gas bubbles 550 are integrated with the surface of the base mold 510 to form a virtual mold surface, and the coating layer of the hardenable fluid 530 covers this virtual mold surface. It is noted that the thickness of the coating layer can be for example between 10 μm and several tens of millimeters, or between 50 μm and 1000 μm, but this is not a restriction. These thicknesses can be adjusted by adjusting the gap between the surface of the base mold and the edge of the knife, for the case where a knife coater is used.

As described below, the condition of the captured gas bubbles is dependent on various conditions including the viscosity of the hardenable fluid and the wettability to the surface of the base mold, but the shape of the concavities 511 on the surface of the base mold 510 is preferably a shape that can form a closed space, or in other words a shape that can prevent the gas remaining in the concavity 511 from escaping when coating with the hardenable fluid. For example, the shape of the concavities can be a pyramid or truncated pyramid such as a triangular pyramid, quadrangular pyramid, pentangular pyramid, hexangular pyramid, or octangular pyramid; a prism such as a triangular prism, quadrangular prism, pentangular prism, hexangular prism, or octangular prism; or a cylinder, cone, truncated cone, or sphere; as well as combined or partially modified shapes thereof, or the like. In these cases, the gas bubbles cannot easily escape when coating with the hardenable fluid, and therefore the gas bubbles can easily be captured. When using truncated pyramid shaped concavities, gas bubbles can generally be easily captured if the aspect ratio (L/D) between the maximum diameter (Lm) and the depth (D) of the opening is 20 or less, 10 or less, or 5 or less.

The size and position of the captured gas bubbles tend generally be adjusted to a certain degree by the position, shape, and size of the concavities in the surface of the base mold that is used, but can also be controlled by adjusting various other parameters, such as the material of the base mold, coating speed, and the travel speed of the blade 540. Finally, the height of the top of the gas bubbles is adjusted to be no higher than the top edge of the concavities.

The hardenable fluid 530 can be any hardenable fluid regardless of the hardening method so long as the fluid has sufficient fluidity to coat the surface of the mold. For example, any liquid or gel organic material, inorganic material, or organic inorganic composite material can be used as the fluid. A liquid resin such as a light hardening resin, aqueous solution of a water-soluble resin, or a solution where a resin is dissolved in various types of solvent can be used, and if the base mold 510 has sufficient heat resistance, a thermoplastic resin or a thermosetting resin can also be used. It is noted that for the case where an inorganic material is used as the hardenable fluid, various types of inorganic materials can be used, such as glass, concrete, plaster, cement, mortar, ceramic, clay, and metal. An organic inorganic composite material that combines these organic materials and inorganic materials can also be used.

Examples of ultraviolet light hardening resins include photopolymeric monomers such as acrylate, methacrylate, and epoxy monomers and photopolymeric oligomers such as acrylate, methacrylate, urethane acrylate, epoxy, epoxy acrylate, and ester acrylate oligomers, to which a photopolymerization initiator has been added. If a UV hardening resin is used, the resin can be hardened in a short period of time without having to subject the mold or the like to a high-temperature.

The thermosetting resin can be an acrylate, methacrylate, epoxy, phenol, melamine, urea, unsaturated ester, alkyd, urethane, or ebonite resin to which a thermal polymerization initiator has been added. If a phenol, melamine, urea, unsaturated ester, alkyd, urethane, or ebonite resin is used for example, the heat resistance and solvent resistance will be superior, and a tough molded part can be obtained by adding a filler.

Examples of soluble resins include water-soluble polymers such as polyvinyl alcohol, polyacrylic acid polymers, polyacrylamide, and polyethylene oxide and the like. For example, when a soluble resin is used, the concentration (viscosity) of the soluble resin solution of the coating layer and the surface tension can be changed in steps in conjunction with the process of removing the solvent by drying, and therefore a structural body with a concave curved surface with a small curvature can be obtained.

If a soluble resin is used as a base mold or a second mold as described later is used for forming, the microlens array layer 561 obtained by the second replication process described later or the hardened layer 531A can be removed (peeled) without being damaged by dissolving these molds.

Examples of the thermoplastic resins include polyolefin resin, polystyrene resin, polyvinyl chloride resin, polyamide resin, and polyester resin and the like.

It is noted that any of the aforementioned resins can contain various types of additives, such as thickening agents, hardening agents, cross-linking agents, initiators, antioxidants, antistatic agents, surfactants, pigments, and dyes and the like. However, the resin materials that are used in this embodiment are not restricted to the aforementioned suggested materials, and various other types of residence can be used either individually, or can be used in combination.

In the steps shown in FIG. 5(c), the coating layer of the hardenable fluid 530 is cured in a condition with gas bubbles 550 captured in the concavities 511 of the base mold 510, and forms a hardened layer 531A. In this step, if an ultraviolet light hardening is used as the hardenable fluid 530, the resin can be polymerized to form a hardened layer 531A by irradiating ultraviolet light onto the coating layer. If a soluble resin solution is used as the hardening resin, a hardened layer 531A can be formed by removing the solvent by drying. Ff a thermoplastic resin is used as the hardenable fluid, a hardened layer 531A can be formed by cooling the resin below a hardening temperature. If a thermosetting resin is used as the hardenable fluid, a hardened layer 531A can be formed by heating the resin above a hardening temperature. Therefore, a hardened layer 531A will be formed with a shape replicated by a replication surface containing the mold surface of the gas bubbles 550 and the base mold 510, or in other words, a plurality of minute concave curved surfaces and trenches enclosing these concave surfaces are arranged on a main surface.

Next, as shown in FIG. 5(d), the hardened layer 531A is removed from the base mold 510. The removed structural body 531B can be used as a master mold for producing the microlens array layer.

As described above, the actual mold surface in the first replication process is formed by the base mold 510 and the gas bubbles 550. The size and shape of the gas bubbles 550 captured in the concavities of the base mold 510 are determined based on various parameters such as the interfacial tension between the gas bubbles and the hardenable fluid, buoyancy, weight, interfacial tension between the gas bubbles and the surface of the base mold, and the interfacial tension between the hardenable fluid and the surface of the base mold and the like.

In the first replication process, a mold surface with substantially a spherical convex shape which conventionally required much formation time can be obtained without using a special process.

The concave curved surface 532 of the structural body 531B obtained by the aforementioned first replication process has a curved surface corresponding to the shape and size of the gas bubbles 550. The curved surface obtained can be a curved surface that is partially substantially spherical, or can be a curved surface deformed by the conditions under which the gas bubbles are placed, but the size and shape of the gas bubbles can be adjusted by the size and shape of the concavities 511 in the base mold 510.

Next, a method of controlling the size, shape, and position of the captured gas bubbles in the first replication process that uses the aforementioned gas bubbles will be described. The size, shape, and position of the concave curved surface 532 of the structural body 531B can be controlled by controlling the size, shape, and position of the gas bubbles. When forming a microlens array layer (structural body 561) using this structural body 531B as a master mold, the size, shape, and position of the convex lenses will also be controlled.

The shape and the size of the gas bubbles 550 can be controlled by adjusting (a) the size and shape of the concavities in the base mold; (b) the viscosity of the hardenable fluid that is applied to the base mold; (c) the speed of coating the hardenable fluid onto the base mold; (d) the pressure used when coating the hardenable fluid onto the base mold; (e) the interfacial tension between the hardenable fluid, base mold, and gas bubbles; (f) the time from coating until hardening of the hardenable fluid; (g) the temperature of the gas bubbles; and (h) the pressure on the gas bubbles; and the like.

Specifically, the gas bubbles 550 can first be adjusted primarily by the size and shape of the concavities 511 in the base mold. The gas bubbles 550 are positioned so as to contact the mold surface in the concavities 511, and are greatly affected by the interfacial tension between the gas bubbles 550 and the hardenable fluid at the interface with the hardenable fluid 530, and therefore attempt to form a convex curved surface. On the other hand, in proximity to the region of contact with the mold surface in the concavities 511, the gas bubbles 550 are also affected by the interfacial tension between the gas bubbles 550 and the mold surface in the concavities 511 and by the interfacial tension between the hardenable fluid 530 and the mold surface in the concavities 511. Therefore, the gas bubbles 550 will form a smooth convex curved surface in the region that contacts with the hardenable fluid, but the curvature and the shape of the convex curved surface can be adjusted by the size and shape of the concavities 511.

The planar shape of the concavities 511 can be a variety of shapes, but if the planar shape of the concavities 511 is a symmetric shape (exhibiting point symmetry or line symmetry) or an approximate shape thereto, the gas bubbles 550 will have favorable symmetry, and a convex curved surface with minimal aberrations can be obtained. In other words, the top of the convex curved surface of the gas bubbles is arranged to be at the center of the substantially symmetrical planar shape, and therefore a smooth convex curved surface with minimal distortion that is suitable for a lens can be obtained.

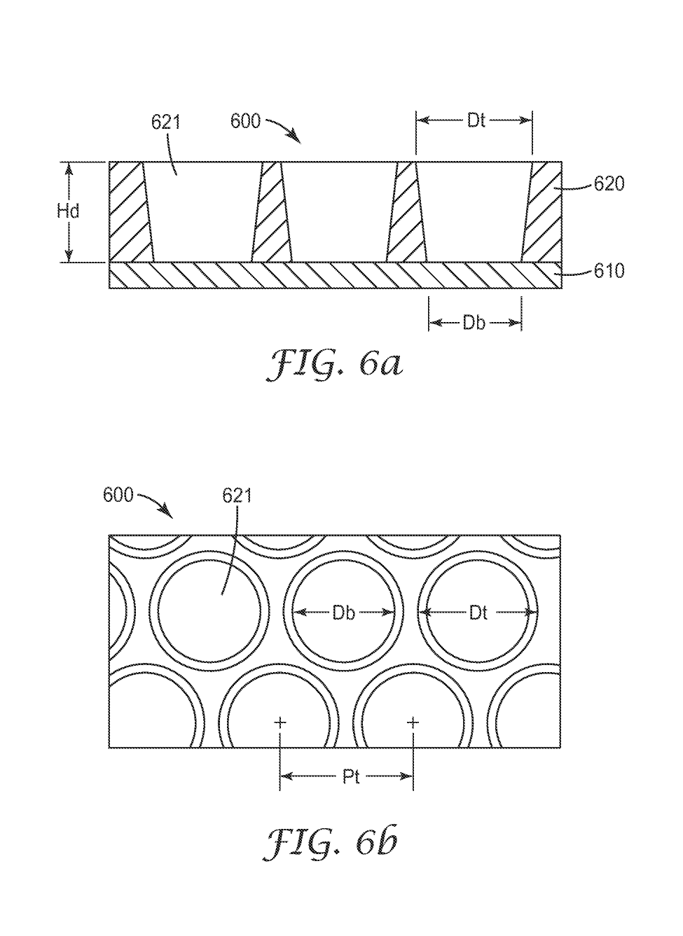

It is noted that the base mold is not necessarily made from a single layer, and a shown in FIG. 6(a), a base mold with a plurality of layers can also be used. For example, a resin layer 620 can be laminated onto a metal sheet 610, and then an opening (concavity) 621 can be formed by laser processing only the resin layer 620. Alternatively, selective etching can be performed using a photolithography process on only one layer of a laminate sheet with a two layer construction to form arranged openings (concavities) 621. With this method, the desired arranged concavity pattern can easily be formed. The depth of the concavities can be adjusted by the thickness of the resin layer.

The size and shape of the gas bubbles 550 can be controlled by adjusting the viscosity of the hardenable fluid 530 that is coated onto the base mold 510. Specifically, the size of the gas bubbles 550 can be increased by increasing the viscosity of the hardenable fluid 530, and the size of the gas bubbles 550 can be reduced by lowering the viscosity of the hardenable fluid 530. Herein, the viscosity of the hardenable fluid is not restricted, but a viscosity of 1 mPas or higher, 10 mPas or higher, or 100 mPas or higher can be suggested. A viscosity of 100,000 mPas or lower, 10,000 mPas or lower, or 1000 mPas or lower can be suggested. It is noted that adjustment of the viscosity can be performed by adding a thickening agent or by adjusting the concentration of the hardenable fluid.

The size and shape of the gas bubbles 550 can also be controlled by adjusting the speed of coating the hardenable fluid onto the base mold 510, or in other words by adjusting the rate of travel of the blade 540 shown by arrow A in FIG. 5(b). Specifically, the size of the gas bubbles 550 can be increased by increasing the coating speed, and the size of the gas bubbles 550 can be decreased by reducing the coating speed. It is noted that the range of adjusting the coating speed can be between 0.01 cm/second and 1000 cm/second, between 0.5 cm/second and 100 cm/second, between 1 cm/second and 50 cm/second, or between 1 cm/second and 25 cm/second, but these are not restrictions. It is noted that the coating speed can be adjusted by the head travel speed for the case where the coating device has a head that feeds the hardenable fluid, or by the rotational speed for the case where the coating device is a spin coater.

For example, if the coating speed is faster than the rate that the hardenable fluid naturally flows down into the concavities on the surface of the base mold, the gas bubbles will easily escape from the concavities. It is noted that the rate of naturally flowing down refers to the rate that the hardenable fluid naturally flows when placed in the concavities of the mold surface, and this value is affected by the viscosity of the hardenable fluid and the interfacial tension and the like between the hardenable fluid, gas bubbles, and mold surface. For example, if the viscosity of the hardenable fluid is extremely low, the gas bubbles can be captured in the concavities by increasing the coating rate or by changing the material of the surface of the base mold.

The size and shape of the gas bubbles 550 can be controlled by the size of the captured gas bubbles 550 by adjusting the interfacial tension between the hardenable fluid 530 and the surface of the base mold 510, the interfacial tension between the hardenable fluid and the gas bubbles 550, and the interfacial tension between the gas bubbles 550 and the surface of the base mold 510.

Whether or not air bubbles 550 are captured, in addition to the size and shape of the captured air bubbles can be affected by the interfacial tension f1 between the hardenable fluid 530 and the surface of the base mold 510, the interfacial tension f2 between the hardenable fluid 530 and the gas bubbles 550, and the interfacial tension f3 between the gas bubbles 550 and the surface of the base mold 510, and can also be affected by the weight, buoyancy, temperature, and pressure. Of these, the capture condition of the gas bubbles 550 can be controlled by adjusting the interfacial tension f1 between the hardenable fluid 530 and the surface of the base mold 510, and as a result, the size and shape of the gas bubbles 550 can also be controlled.

Specifically, the size of the gas bubbles 550 can be increased by increasing the contact angle (reducing the wettability) between the hardenable fluid 530 and the surface of the base mold 510, and the size of the gas bubbles 550 can be reduced by reducing the contact angle (increasing the wettability) between the hardenable fluid 530 and the surface of the base mold 510.

For example, if a polyester-based urethane acrylate which is a UV light hardening is used as the hardenable fluid 530, a contact angle that can easily capture gas bubbles can be obtained by using a resin such as a silicone resin, polypropylene, polystyrene, polyethylene, polycarbonate, or polymethylmethacrylate, or a metal material such as nickel as the base mold 510.

The contact angle between the hardenable fluid 530 and the surface of the base mold 510 can be adjusted by processing of the surface of the base mold. For example, the contact angle can be adjusted by a surface treatment using a liquid, plasma treatment, or other treatment method.

The size and shape of the gas bubbles 550 can be controlled by adjusting the time until hardening the hardenable fluid 530 that was coated, or by adjusting the temperature and pressure in the step shown by FIG. 5(c). Specifically, the size of the gas bubbles can be increased by shortening the time from coating until hardening, and the size of the gas bubbles 550 can be reduced by lengthening the time from coating until hardening.

Next, the second replication process of the manufacturing method of the microlens array layer of the present embodiment is described below while again referring to FIG. 5(e) and FIG. 5(f).

The second replication process can be a standard conventional replication process. First, as shown in FIG. 5(e), the structural body 531B with a concave curved surface obtained by the aforementioned first replication process is prepared as the second mold, or in other words the master mold (if necessary, the “structural body” can be interpreted to be “the second mold” or “the master mold”), and then as shown in FIG. 5(f), the hardenable fluid 560 is coated onto the replication surface of the second mold 531B such that gas bubbles do not remain.

The second mold 531B in the second replication process can be made by hardening the hardenable fluid that was used in the first replication process as described above, but an optimal material can be selected based on the application from UV light hardenings, soluble resins, thermoplastic resins, thermosetting resins, as well as other organic materials, inorganic materials, and organic or inorganic composite materials and the like.

A UV hardening resin or soluble resin solution can be used as the hardenable fluid 560 that is coated on the second mold 531B. If the second mold 531B has sufficient heat resistance, a thermoplastic resin or a thermosetting resin can also be used. Other organic materials, inorganic materials, or organic and inorganic composite materials in the light can be used so long as it is a curable material. It is noted that if the hardened layer will be removed from the second mold 531B after hardening, an easily removable material is preferably selected.

The method of coating the hardenable fluid 560 onto the replication surface of the second mold 531B can be a method that uses various types of coating devices such as a knife coater, bar coater, blade coater, or roll coater. In the second process, air is not necessarily captured on the mold surface, and standard conventional replication conditions can the used, so coating under reduced pressure conditions is also acceptable. Alternatively, a reduced pressure treatment can be reformed after coating, and a degassing process can also be performed.

Continuing, the hardenable fluid 560 is hardened after coating, and then as shown in FIG. 5(f), the structural body 561 which is a solid is removed from the second mold 531B.

If the hardenable fluid 560 is a UV hardening resin, hardening can be performed by ultraviolet light irradiation, and if the hardenable fluid 560 is a soluble resin solution, hardening can be performed by drying. If the hardenable fluid is a thermoplastic resin, hardening can be performed by cooling the resin below a hardening temperature, and if the hardenable fluid is a thermosetting resin, hardening can be performed by heating the resin above a hardening temperature.

A structural body 561 with convex curved surfaces 562 and surrounding partition walls 563 can be obtained by replicating the second mold 531B obtained by the first replication process. The structural body 561 can be used as the microlens array layer of the present embodiment. Therefore, with the present embodiment, a microlens array layer containing a two-dimensional convex lens array and surrounding partition walls which conventionally has required much operation time to form can be achieved using a simple process without special processing.

It is noted that the second replication process does not require gas bubbles to be arranged on the replication surface, and therefore can be replaced with various types of conventional replication processes. For example, replication can be performed by a method such as thermal pressing or electrocasting by using the second mold.

The convex lenses and partition walls of the microlens array layer obtained by the second replication process have a size and shape that corresponds to the concavities of the base mold used in the first replication process and the captured gas bubbles 550.

Furthermore, if the trenches and the concave curved surfaces 532 of the second mold 531B in the microlens array layer which is the structural body 561 are substantially equal, a microlens array layer can be obtained with convex lenses that have substantially the same shape and surrounding partition walls that have the same height.

It is noted that if only the second mold 531B is formed from a soluble resin material that can dissolve in specific solutions such as an aqueous resin or the like, the microlens array layer can be obtained by a method of dissolving the second mold 531B in a solvent rather than physically removing the structural body 561 which is the microlens array layer from the second mold 531B. Even if the structural body 561 is difficult to physically remove, the microlens array layer can be obtained without causing damage by dissolving the second mold 531B in solvent.

In the aforementioned process, the second mold is used as the master mold, but if the structural body obtained by the replication process using the second mold is used as a third mold in a third replication process, a separate master mold can be formed with the same shape as the second mold which is the master mold of the microlens array layer. For example, a metal master mold can be formed by metal coating using a method such as electrocasting on the surface of the second mold and then removing the metallic structural body obtained. The metal master mold obtained will be heat resistant and hard, and therefore can be used as a stamper for a press process. It is noted that the replication processes after the second replication process can be standard replication processes, and these processes can be repeatedly performed. Any mold with concave curved surfaces obtained by this series of replication processes can be used as the master mold. Any microlens array layer obtained using a master mold obtained by any process that includes at least the first replication process that uses gas bubbles will be comparable to the microlens array layer of this embodiment, and the lens obtained is a lens obtained by replicating the gas bubble shape.

The microlens array layer of this embodiment has partition walls that correspond to the shape of the surface of the base mold in the area around the lens parts that replicate the gas bubble shape.

It is noted that if the second mold is not used as the master mold, the hardenable fluid that is used in the second replication process using the second mold will not be directly used as the microlens layer, and therefore the use of a material that is transparent in the visible light range will not be necessary, and the hardenable fluids that can be used in the first replication process can be used. If the microlens layer is formed by a press process using a master mold, a thermal plastic resin that is transparent in the visible light range can be used as the material of the microlens layer.

The microlens sheet of the present embodiment can be obtained by a laminating an individual radiation sensitive layer, or a laminate body containing a radiation sensitive layer as shown in FIG. 1 through FIG. 3 on the second surface where the convex lenses and the partition walls of the microlens array layer obtained by the aforementioned method are formed.

### EXAMPLES

Working examples of the present disclosure are described below, but naturally the scope of the present disclosure is not restricted to these examples.

### Fabricating the Microlens Array Layer

First, a sheet-like first structural body was fabricated with a pattern of concavities by replicating gas bubbles using the following procedures. As the base mold, a laminated sheet with a two-layer structure including a copper foil with a thickness of 20 μm laminated on a polyimide layer with a thickness of 25 μm was prepared (trade name: TWO LAYER COPPER CLAD SUBSTRATE, made by Japan Interconnection Systems, Ltd.). The polyimide layer of the laminated sheet was processed using a laser to produce holes in a region with a side length of 100 mm (processing by Tosei Electrobeam Co., Ltd.), giving the resulting base mold a matrix pattern of conic concavities.FIG. 6(a) is a partial cross-sectional view showing the resulting base mold, and FIG. 6(b) is a partial top view of the same. The concavities formed in the base mold 600 had a depth (Hd) of 25 μm, a concavity top opening diameter (Dt) of 53 μm, a concavity bottom opening diameter (Db) of 42 μm, and a concavity arranged pitch (Pt) of 60 μm.

An ultraviolet hardening resin was prepared by mixing 90 parts by weight of a polyester-based urethane acrylate monomer (trade name: EBECRYL8402, manufactured by Daicel-Cytec Co., Ltd.), with 10 parts by weight of unsaturated fatty acid hydroxyalkyl ester-modified ε-caprolactone (trade name: Placcel™ FA2D, manufactured by Daicell Chemical Industries, Ltd.) and 1 part by weight of a photopolymerization initiator (trade name: Irgacure 2959, manufactured by CIBA Specialty Chem. Inc.).

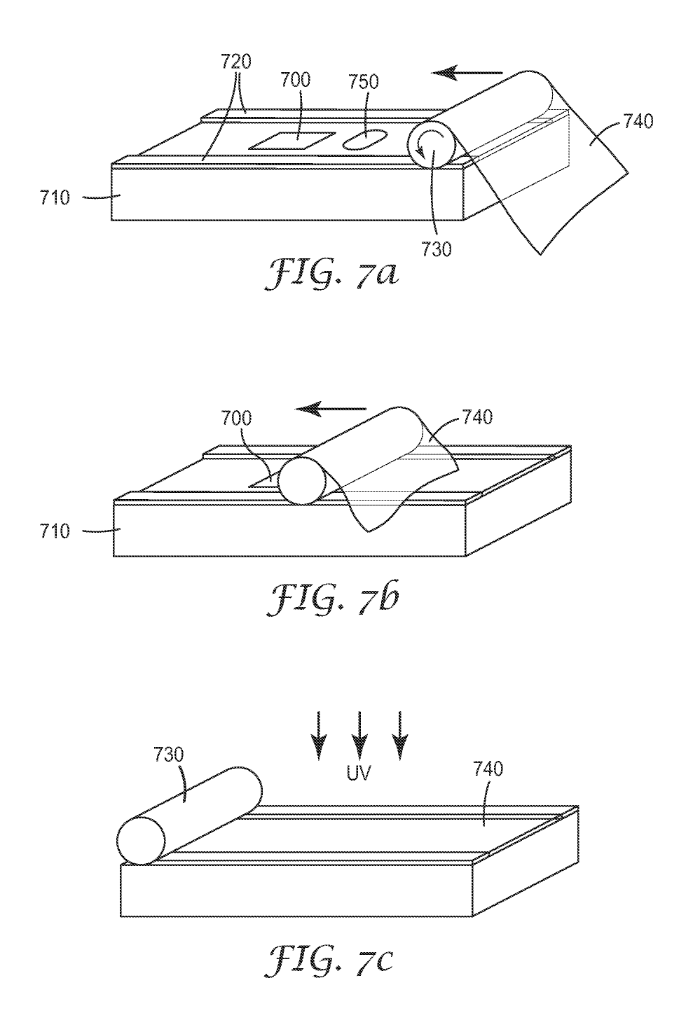

As shown in FIG. 7(a), a base mold 700 (600) fabricated by the aforementioned procedures was placed on a surface plate 710 having a smoothness of plus or minus 5 μm and suction holes with a diameter of 1 mm provided at an interval of 120 mm, and suction was applied via the suction holes using a rotary pump to fix the base mold 700 in place. Thereafter, a stainless steel sheet with a thickness of 800 μm and a PET film with a thickness of 188 μm were placed at both ends of the base mold 700 as a spacer 720. On the other hand, the surface of a laminate roller 730 with a diameter of 200 mm, a weight of 300 kg, and a length of 1500 mm and coated with 5 mm thick silicone rubber that had been antistatic treated was provided at one end of the surface plate 710. As shown in FIG. 7(a), a PET film was placed under the laminate roller 730, and then a UV hardening resin 750 was uniformly applied by dripping along the edge of the base mold on the laminate roller 730 side of the surface plate 710 of the base mold 700. Next, the laminate roller 730 was rotated and moved in the direction of the arrow in FIG. 7 at a speed of 1.42 mm/second using a servomotor connected to both ends. As shown in FIG. 7(b), the ultraviolet hardening resin 750 was simultaneously coated onto the base mold 700 while laminating the PET film 740 onto the base mold 700. Under these conditions, air was captured in the concavities of the base mold 700.

As shown in FIG. 7(c), ultraviolet light (365 nm) from a UV lamp was irradiated onto the UV hardening resin 750 through the laminated PET film 740 to polymerize and harden the UV hardening resin.

The polymerized and hardened UV hardening resin layer was removed from the base mold 700 to obtain a structure with concave curved surfaces replicated by gas bubbles captured between the base mold and the concavities therein and surrounding grooves, or in other words, a sheet-like first structural body having a pattern of arranged concavities on the surface thereof as shown in FIG. 5(d). Next, a nickel layer was formed by electrocasting onto the first structural body obtained (second mold). Specifically, a nickel plating bath containing 600 g/L of nickel sulfamate, 30 g/L of boric acid, and 0.1 g/L of sodium dodecyl sulfate with a pH of 0.4 and a temperature of approximately 50 degrees Celsius was prepared, and then electrodeposition was performed by immersing the first structural body coated with silver on the surface thereof to produce a nickel layer with a thickness of approximately 500 μm or more. Next, the nickel layer obtained was removed (peeled) from the second mold to obtain a nickel mold (third mold) with a pattern of arranged convex parts on the surface with partition walls surrounding each convex part, as shown in FIG. 5(f).

Electrocasting was performed by the same method at the aforementioned conditions onto the surface of the nickel mold (third mold) to form a nickel layer with a thickness of approximately 500 μm or more. Next, the nickel layer was removed (peeled) from the nickel mold to obtain a nickel mold with a pattern of arranged concavities (concave mold: fourth mold). The nickel fourth mold obtained in this manner was used as a master mold for forming a microlens array layer.

The master mold (fourth mold) was set on the top plate of a press with a set of top and bottom metal plates, and a 2 mm thick acrylic resin or polymethylmethacrylate resin (PMMA) plate was placed on the bottom plate. The top plate where the master mold was placed was set to 175 degrees Celsius, and the bottom plate where the PMMA plate was placed was set to 70 degrees Celsius, and then the master mold was pressed onto the PMMA plate from the top and bottom with a force of 190 kN, and this condition was maintained for approximately 150 seconds. Therefore, a pattern with arranged convex lenses and partition walls was replicated onto one surface of the PMMA plate to produce a PMMA microlens array layer with a thickness of 2 mm.

### Microlens Sheet

Next, a laminate body that contains a radiation sensitive layer was placed on the second surface of the microlens array layer obtained to produce a microlens sheet 1, 2. Two types of laminate bodies were prepared (laminate body 1, laminate body 2).

### Microlens Sheet 1

A commercial PET film with aluminum electrodeposition layer (product name Scotch Tint™ film manufactured by Sumitomo 3M Ltd. (part number: RE18SIAR) was used as the laminate body 1 containing the radiation sensitive layer. The laminate body 1 has the same structure as the laminate body 320 shown in FIG. 3, a 2 mm thick acrylic coating layer is provided on one surface of a 50 μm thick PET film, on the other surface, an aluminum vapor deposition layer with a thickness of approximately 1 μm, an adhesive layer, and a PET peeling sheet provided in order. Herein, the aluminum vapor deposition layer was used as the radiation sensitive layer.

This laminate body 1 was placed on the second surface of the microlens array layer such that the acrylic coating layer was in contact with the end surfaces of each of the partition walls to obtain the microlens sheet 1 of this working example.

The combined height F of the height (Hw) of the partition walls of the microlens array layer of 22 μm, the thickness of the acrylic coating layer of 2 μm, and the thickness of the PET film of 50 μm was equal to approximately 74 μm, and the radiation sensitive layer was substantially located at the position of the focal length of the convex lenses.

### Microlens Sheet 2

A commercial PET film with an aluminum vapor deposition layer (product name: Metalumy TS#100, product of Toray Advanced Film Co., Ltd.) coated on one surface with urethane acrylate was used as the laminate body 2 containing the radiation sensitive layer. The laminate body 2 has the same structure as the laminate body 220 shown in FIG. 2, with approximately a 1 μm thick aluminum vapor deposition layer formed on one surface of a 100 μm thick PET film. Herein, the aluminum vapor deposition layer was used as the radiation sensitive layer.

A urethane acrylate resin was prepared by mixing 90 parts by weight of a polyester-based urethane acrylate monomer (trade name: EBECRYL8402, manufactured by Daicel-Cytec Co., Ltd.), with 10 parts by weight of unsaturated fatty acid hydroxyalkyl ester-modified ε-caprolactone (trade name: Placcel™ FA2D, manufactured by Daicel Chemical Industries, Ltd.) and 1 part by weight of a photopolymerization initiator (trade name: Irgacure 2959, manufactured by CIBA Specialty Chem. Inc.). The resin obtained was laminated onto the aluminum vapor deposition layer using a knife coating method, and then ultraviolet light (365 nm) from a UV lamp was irradiated to polymerize and harden the resin. A urethane acrylate layer with a thickness of approximately 58 μm was obtained. The laminate body 2 obtained was placed on the second surface of the microlens array layer so that the urethane acrylate layer with self tackiness was in contact with the end surfaces of each of the partition walls, and the microlens sheet 2 of this working example was obtained by laminating with a hand roller. The combined height F of the height (Hw) of the partition walls of the microlens array layer of 22 μm and the thickness of the urethane acrylate layer of 58 μm was equal to approximately 80 μm, and the radiation sensitive layer was substantially located at the position of the focal length of the convex lenses.

### Forming a Composite Three-Dimensional Image

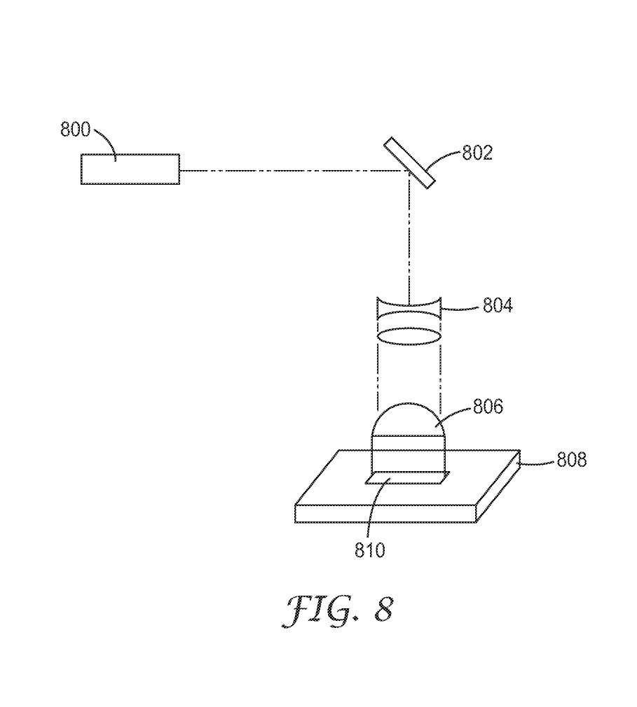

A floating image was created by the same method as the first working example in “sheet with a Floating Composite Image” disclosed in PCT International Publication No. WO 01/063341 with regards to the two types of microlens sheets 1, 2 that were obtained. Specifically, using an optical system such as that shown in FIG. 8, a a Q-switched Nd:YAG laser 800 with a basic wavelength of 1047 nm (EdgeEave INNOSLAB™ type IS4I-E laser device (Nd: YLF crystal)) was used to irradiate a microlens sheet 810 placed on a testtable 808 whose position can be adjusted on three axes X, Y, and Z, via a 99% reflective mirror, a 5× beam expansion telescope 804, and an aspherical lens 806 with a numerical aperture of 0.64 and a focal length of 39.0 mm. Note that the laser has a pulse width of 10 ns or less and a repetition frequency between 1 and 3000 Hz. The microlens sheet 810 was installed on the test table 808 with the surface of the convex lens array facing upwards.

The test table 808 was a commercially available AGS 15000 brand (manufactured by Areotech Inc., Pittsburgh, Pa.) and included three linear tables. A first linear table was used to the move the aspherical lens along an axis (Z-axis) between the focal point of the aspherical lens and the microlens sheet 810. The other two stages were used to move the microlens sheet along two mutually orthogonal horizontal axes relative to the optical axis.

In this example, the aspherical lens 806 was positioned so that the focal point thereof was at a position 1 cm above the microlens sheet 810. A LabMax™—top power meter and EneryMax™ 50 mm diameter sensors manufactured by Coherent Inc., Bridgeport, Oreg., USA were used in order to control the energy density of the irradiation of the microlens sheet. The laser output was adjusted to obtain a laser irradiation energy density of approximately 8 mJ/square centimeter (8 mJ/cm²) at a position 1 cm from the focal point of the aspherical lens 806.

A commercially available A3200 controller manufactured by Aerotech Inc, Pittsburgh Pa. was used to move the sample stage 808 and control the pulse-controlling voltage supplied to the laser 800. The test table 808 was moved two dimensionally in the X and Y directions and the characters “3M” were drawn by a laser beam on the radiation sensitive layer of the microlens sheet by adjusting the movement of the X, Y, and Z tables by pulsing the laser in order to draw a floating image on the microlens sheet 810. The test table was moved at a speed of 50.8 cm/min, for a laser pulse rate of 10 Hz.

### Evaluation of the Microlens Sheet Material

The shape of the obtained microlens array was measured using an optical microscope (trade name: BX51, product of Olympus Co., Ltd.).Specifically, the radius of the curvature r of each of the convex lenses, the height of the lens part h1, and a height of the partition wall portions (Hw) were measured. The measurements were performed at two different locations by taking photographs at 50× magnification and finding an average value thereof. According to the results, r was 22 μm, h1 was 19 μm, and Hw was 22 μm.

A lens number and lens density were then measured at two different locations by taking photographs at 10× magnification using the same optical microscope. According to the results, it was possible to confirm that the obtained microlens array had a lens density of 30509 units/cm². For comparison, measurements under the same conditions were made on a conventional microlens sheet product which used glass beads (trade name: Scotch Lite ®680-10, manufactured by Sumitomo 3M Co., Ltd.), as a microlens sheet for forming a three-dimensional image. The lens diameter was 70 μm and the lens density was 15385 units/cm².

The visibility of the image was confirmed when the microlens sheet with images of characters drawn thereon was lit from the rear surface with a fluorescent light, and when the microlens sheet was lit from the front by room lighting (fluorescent lighting). When lighting from the back surface with a fluorescent light, the image was formed by transmitted light, and when lighting from the front with a fluorescent light, the image was created by the light reflected by the layer of deposited aluminum that forms the radiation sensitive layer. However, it was confirmed in both cases that an image of the drawn characters appeared to float above the microlens sheet.

1. A microlens sheet comprising:
a microlens array layer including
a first surface, and
a second surface formed by replication, the second surface having a plurality of
arranged convex lenses and one or more partition walls with a fixed height (Hw)
higher than a top of the convex lenses; and
a radiation sensitive layer which is disposed substantially at a focal position of the convex lenses on a side of the microlens array layer opposite the first surface, and which is substantially parallel to the second surface.

2. The microlens sheet according to claim 1, wherein the radiation sensitive layer is disposed adjacent to the second surface and the radiation sensitive layer is supported by the partition walls, and each surface of the convex lenses is separate from the radiation sensitive layer.

3. The microlens sheet according to claim 2, wherein a distance (F) between the second surface and the radiation sensitive layer is substantially equal to the height (Hw) of the partition wall(s).

4. The microlens sheet according to claim 1, further comprising a laminate body which includes the radiation sensitive layer, wherein
the laminate body is disposed adjacent the second surface and is supported by the partition wall(s), and each surface of the convex lenses is separate from the laminate body.

5. The microlens sheet according to claim 4, wherein the laminate body includes one or more resin layer(s) between the second surface and the radiation sensitive layer, and the distance (F) between the second surface and the radiation sensitive layer is substantially equal to the sum of the height (Hw) of the partition wall (s) and the thickness of the resin layer(s) located between the second surface and radiation sensitive layer.

6. The microlens sheet according to claim 1, wherein each of the convex lenses is formed by replicating a gas bubble shape.

7. The microlens sheet according to claim 1, wherein the partition walls are adjacent to each of the convex lenses and surrounding each of the convex lenses.

8. The microlens sheet according to claim 1, further comprising a composite image that appears to a naked eye of an observer to be floating at above or below the sheet.

9. A manufacturing method of a microlens sheet comprising:
preparing a mold comprising a mold surface which has a plurality of concavities, each of which is inverse of the convex lens shape, and one or more fixed-depth trenches each of which is deeper than the concavities;
replicating the mold surface so as to form a microlens array layer having a first surface, and a second surface with a plurality of convex lenses formed by replication; and
disposing a radiation sensitive layer substantially at the focal position of the convex lenses on a side of the microlens array layer opposite the first surface and substantially parallel to the second surface.

10. The method according to claim 9, wherein the step of preparing a mold comprises:
providing a base mold having a mold surface with an arranged concavity pattern;
applying a hardenable fluid onto the mold surface while entrapping gas bubbles at each of the concavities in the arranged concavity pattern; and
hardening the hardenable fluid.
